(19) United States
(12) Patent Application Publication
(10) Pub. No.: US 2012/0113643 A1
(43) Pub. Date: May 10, 2012

(54) LED LAMP

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/300,634

(22) Filed: Nov. 20, 2011

Related U.S. Application Data
(66) Substitute for application No. 12/939,182, filed on Nov. 4, 2010, now abandoned.

(51) Int. Cl. F21V 15/01; F21V 21/00

(52) U.S. Cl. 362/249.02; 362/365

(57) ABSTRACT

An LED lamp includes a lamp body and a lamp cover. The lamp body includes a bottom plate, two side plates extending upwardly from the bottom plate and two end covers set at two opposite ends of the lamp body. The bottom plate, the side plates and the end cover together form a receiving space for receiving light sources. A pair of slots is defined in the two side plates respectively and the lamp cover is inserted into the slots. A baffle plate is set at one end of the lamp body and forms a pivotal connection with the lamp body for preventing the lamp cover from slipping out of the slot. The baffle plate is movable between a first position to engage with the lamp cover and a second position to expose the lamp cover.

### TECHNICAL FIELD

The disclosure generally relates to an LED lamp which is convenient to assemble.

### DESCRIPTION OF RELATED ART

In recent years, lamps are widely used in people's daily life, and gradually developed to have more and more different types according to the exact environments where they are applied, including road lamp, tunnel lamp, underwater lamp, landscape lamp, parking lamp, vehicle lamp, washing lamp, ceiling lamp traffic lamp, etc.

Generally, an LED lamp includes a lamp body and a lamp cover. For some kind of lamp such as advertising lamp, the lamp cover needs frequently change for showing different information. However, a conventional lamp generally needs multiple processes to finish the installation. If the lamp needs frequently change, the assembly of the conventional lamp is inconvenient.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a perspective view of an LED lamp of the present disclosure.

FIG. 2 is an exploded view of the LED lamp of FIG. 1.

FIG. 3 is a cross-sectional view of the LED lamp in FIG. 1.

FIG. 4 is a perspective view of a baffle plate of the LED lamp of FIG. 2.

FIG. 5 is a perspective view of a baffle plate in accordance with another embodiment.

### DETAILED DESCRIPTION

Embodiments of an LED lamp will now be described in detail below and with reference to the drawings.

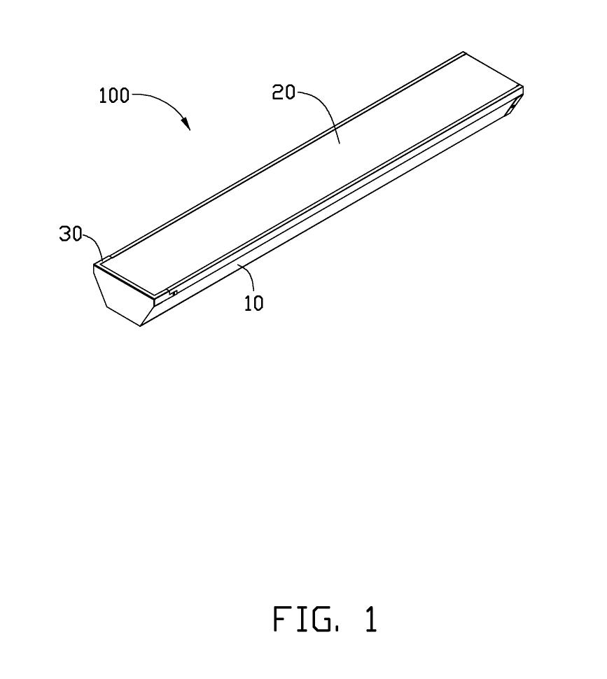

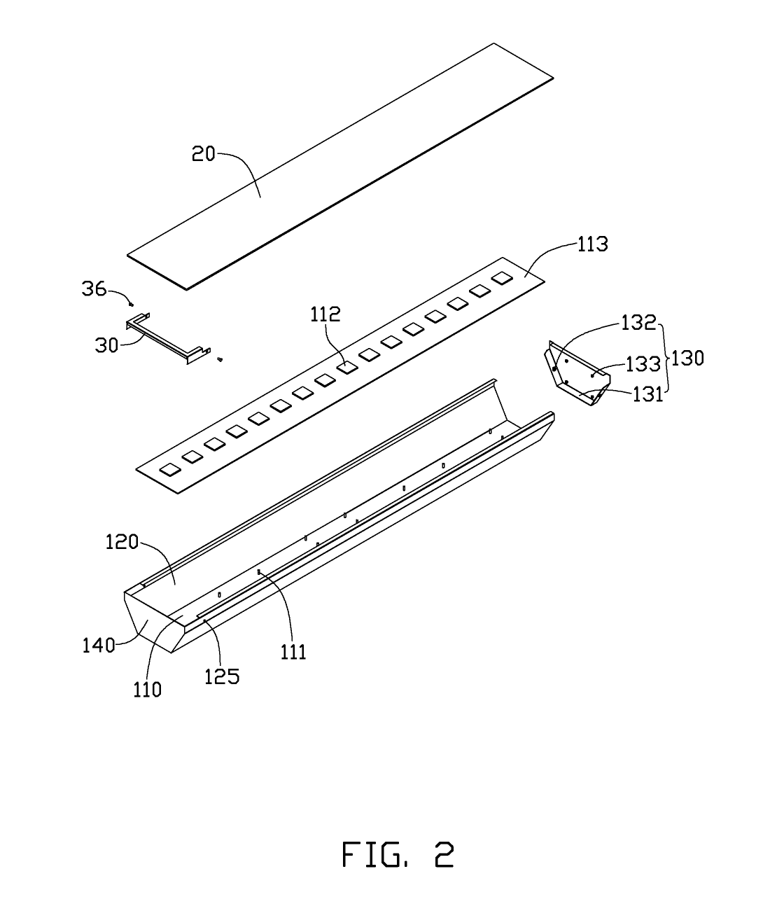

Referring to FIG. 1 and FIG. 2, an LED lamp 100 in accordance with a first embodiment is shown. The LED lamp 100 includes a lamp body 10, a lamp cover 20 and a baffle plate 30 fixed to the lamp body 10.

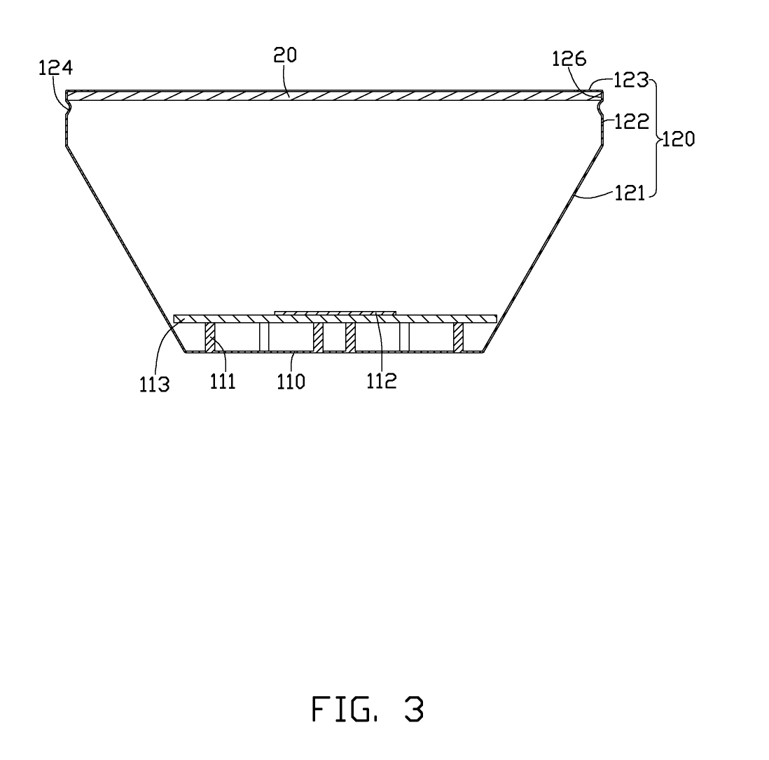

Referring also to FIG. 3, the lamp body 10 includes a bottom plate 110, a pair of side plates 120 extending upwardly and inclinedly from two opposite sides of the bottom plate 110, and two end covers 130, 140 respectively secured at two opposite ends of the lamp body 10. The bottom plate 110, side plates 120 and end covers 130, 140 together form a receiving space for receiving light sources 112 such as light emitting diodes (LEDs) or laser diodes (LDs) therein. The light from the light sources 112 can emit to the environment through the opening of the receiving space. In this embodiment, a plurality of supporting poles 111 are formed on the bottom plate 110 for supporting a printed circuit board 113. The light sources 112 are arranged on a surface of the printed circuit board 113 opposite to the supporting poles 111. Each of the side plates 120 includes a connecting part 121, a fixing part 122 and a flange 123 extending sequentially from the bottom plate 110. The connecting part 121 is bent from the bottom plate 110 in a manner that it defines an angle of 120 degrees with the bottom plate 110. The connecting parts 121 flare upwardly from the two opposite sides of the bottom plate 110. The fixing part 122 is connected with the connecting part 121 at one side opposite to the bottom plate 110. The fixing part 122 is vertical to the bottom plate 110, and a groove 124 is defined in a top of the fixing part 122 by stamping the fixing part 122. The grooves 124 open oppositely outwardly. The groove 124 is parallel to the bottom plate 110 and extends from one end of the lamp body 10 to the other end thereof. A second hole 125 is further defined in the fixing part 122 at a position adjacent to the end cover 140. The flange 123 is defined at the end of the side plate 120. The flange 123 is bent inwardly and horizontally from the fixing part 122 and parallel to the bottom plate 110. The flange 123 and the groove 124 together form a slot 126 for supporting the lamp cover 20. The lamp cover 20 can be inserted into the slot 126 and connected with the lamp body 10. The first end cover 130 is detachable from the lamp body 10 and fixed to the side plate 120 by screws. The end cover 130 has a trapezoid shape. Flanges 131 are defined at the edges of the end cover 130. Fixing holes 132 are defined in the flanges 131 for screws to pass through and fix the end cover 130 to the side plate 120. In addition, a through hole 133 is further defined in the end cover 130 for allowing electrical wires to extend therethrough into the lamp body 10 to connect the light sources 112 with a power supply. The second end cover 140 is inseparable from the lamp body 10. Generally, the second end cover 140 is integrally bent upwardly and vertically from the bottom plate 110.

The lamp cover 20 can be inserted into the slot 126 from one end of the lamp body 10 near the baffle plate 30. The flange 123 and the groove 124 are secured at opposite top and bottom surfaces of the lamp cover 20. The material of the lamp cover 20 is selected from the group consisting of glass, polycarbonate (PC) and polymethyl methacrylate (PMMA).

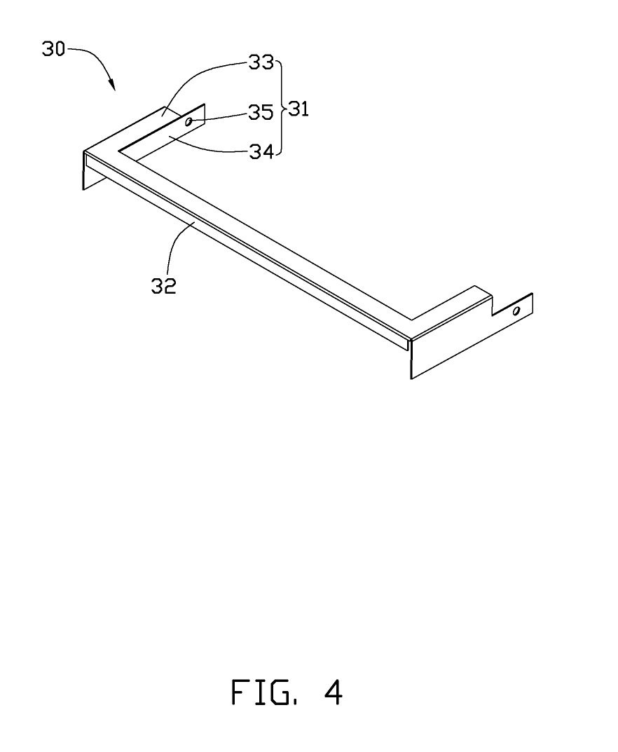

Referring also to FIG. 4, the baffle plate 30 is fixed to the lamp body 10 at one end thereof adjacent to the second end cover 140. The baffle plate 30 includes a fixing portion 31 and a baffle portion 32. The fixing portion 31 includes a top wall 33 and a side wall 34 extending downwardly and vertically from an outer side of the top wall 33. The fixing portion 31 is used for fixing the baffle plate 30 to the lamp body 10. A first holes 35 is defined in each side wall. The position of the first hole 35 is corresponding to that of the second hole 125. A fixing element 36 such as a screw passes through the first hole 35 and the second hole 125 and makes the baffle plate 30 form a pivotal connection with lamp body 10. The baffle portion 32 is also bent vertically downwardly from the top wall 33 and formed between the two side walls 34. The baffle portion 32 is used for preventing the lamp cover from slipping out of the slot 126.

When the LED lamp 100 is assembled, a printed circuit board 113 having the light sources 112 thereon is firstly installed to the supporting poles 111 and then the first end cover 130 is fixed to the side wall 120 by screws. After that, the baffle plate 30 is fixed to the lamp body 10 by the fixing element 36 and the baffle plate 30 is turned around the fixing element 36 to expose the slot 126 in the lamp body 10. And then the lamp cover 20 is inserted into the slot 126 from the one end of the lamp body 10 near the baffle plate 30. Finally, the baffle plate 30 is turned around the fixing element 36 in a reversed direction until the baffle portion 32 covers the slot 126 and prevent the lamp cover 20 from slipping out of the slot 126. If the lamp cover 20 needs replacement, the baffle plate 30 is turned around the fixing element 36 for exposing the lamp cover 20. Then the lamp cover 20 is pulled out of the slot 126. The new lamp cover 20 can be installed in a similar process described above. Therefore, the replacement of the lamp cover 20 in accordance with the present disclosure is convenient. In addition, because the groove 124 is formed by stamping the side wall 120 inwardly, the slot 126 can be easily formed on the side wall 120 by a simple processing of a metal sheet.

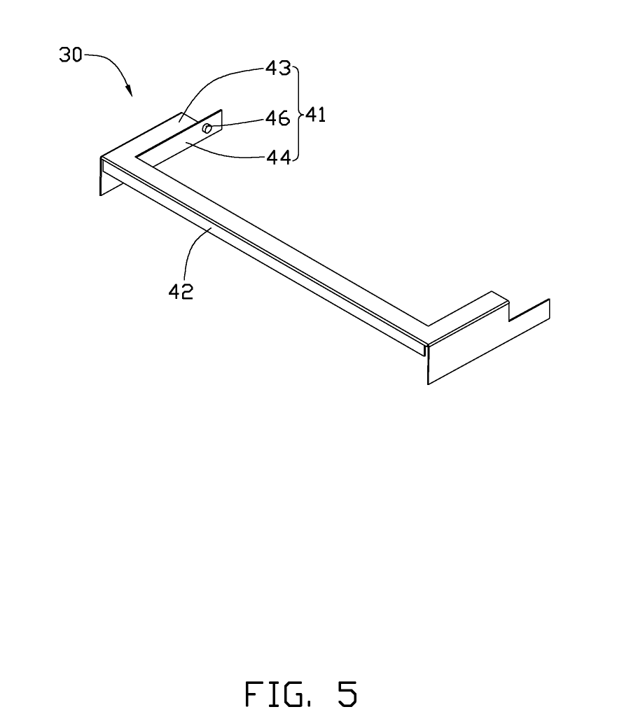

The baffle plate is not limited to the above embodiment. Referring to FIG. 5, a baffle plate 40 in accordance with a second embodiment is provided. The baffle plate 40 can replace the baffle plate 30 in FIG. 2. The baffle plate 40 includes two fixing portions 41 at two lateral sides thereof and a baffle portion 42 between the two fixing portions 41. Each fixing portion 41 includes a top wall 43 and a side wall 44 extending downwardly and vertically from the top wall 43. The baffle portion 42 is bent downwardly the top wall 43 and formed between the two side walls 44. Different from the first embodiment, a pair of protrusions 46 is formed on inner part of the side walls 44 respectively. The protrusions 46 are inserted into the second holes 125 to fix the baffle plate 40 to the lamp body 10 and make the baffle plate 40 form a pivotal connection with the lamp body 10. The second embodiment does not need extra fixing elements such as screws for fixing the baffle plate 40 to the lamp body 10.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An LED lamp comprising:
a lamp body comprising a bottom plate, two side plates extending upwardly from the bottom plate and two end covers secured at two opposite ends of the lamp body, the bottom plate, the side plates and the end covers together form a receiving space for receiving light sources, each side wall defining a slot extending from one end of the lamp body to the other end thereof;
a lamp cover inserted into the slot and connected with the lamp body;
a baffle plate set at one end of the lamp body for preventing the lamp cover from slipping out of the slot, the baffle plate forming a pivotal connection with the lamp body and movable between a first position to engage with an end of the lamp cover and a second position to expose the end of the lamp cover.

2. The LED lamp of claim 1, wherein the baffle plate comprises two fixing portions and a baffle portion between the two fixing portions, each fixing portion is for fixing the baffle plate to the lamp body and the baffle portion is for blocking the lamp cover.

3. The LED lamp of claim 2, wherein each fixing portion comprises a top wall and a side wall extending downwardly from the top walls, the baffle sheet is bent downwardly from the top walls and formed between the two side walls of the two fixing portions.

4. The LED lamp of claim 3, wherein a pair of first holes are defined in the two side walls respectively, and a pair of second holes are respectively defined in the two side plates in a position corresponding to the first holes, a fixing element passes through the first hole and the second hole for forming the pivotal connection between the baffle plate and the lamp body.

5. The LED lamp of claim 3, wherein a pair of protrusions are formed on inner side of the two side walls respectively, and a pair of second holes are respectively defined in two side plates in a position corresponding to the protrusions, each protrusion is inserted into the corresponding second hole for forming the pivotal connection between the baffle plate and the lamp body.

6. The LED lamp of claim 1, wherein each of the side plates includes a connecting part, a fixing part and a flange sequentially extending from the bottom plate.

7. The LED lamp of claim 6, wherein the connecting part is bent from the bottom plate in a manner that the connecting part defines an angle of 120 degrees with the bottom plate.

8. The LED lamp of claim 6, wherein a groove is defined in the fixing part and extending from one end of the lamp body to the other end thereof.

9. The LED lamp of claim 8, wherein the groove is formed by stamping the fixing part inwardly.

10. The LED lamp of claim 8, wherein the flange and the groove form the slot together and secured at two opposite surfaces of the lamp cover.

11. The LED lamp of claim 1, wherein a plurality of supporting poles are formed on the bottom plate for supporting a printed circuit broad, the light sources being mounted on the printed circuit board.

12. The LED lamp of claim 11, wherein the light sources are arranged on a surface of the printed circuit broad opposite to the supporting poles.

13. The LED lamp of claim 1, wherein the light sources are light emitting diodes or laser diodes.

14. The LED lamp of claim 1, wherein the two end covers comprises a first end cover integrally connected with the bottom plate and the side plate and a second end cover is separably fixed to the bottom plate and the side plate.

15. The LED lamp of claim 14, wherein the second end cover comprises flanges extending vertically from the bottom thereof, and a fixing hole is defined in the flanges for fixing the second end cover to the side plate.

16. The LED lamp of claim 14, wherein a through hole is defined in the second end cover allowing electrical wires to extend therethrough into the lamp body to connect the light sources with a power supply.

17. The LED lamp of claim 1, wherein the material of the lamp cover is selected from the group consisting of glass, polycarbonate and polymethyl methacrylate.
